(19) United States
(12) Patent Application Publication
(10) Pub. No.: US 2015/0030190 A1
(43) Pub. Date: Jan. 29, 2015

(54) HEARING ASSISTANCE DEVICE WITH ANTENNA OPTIMIZED TO REDUCE HEAD LOADING

(71) Applicant: Starkey Laboratories, Inc., Eden Prairie, MN (US)

(72) Inventors: Jay Rabel, Shorewood, MN (US); Casey Murray, Eden Prairie, MN (US)

(73) Assignee: Starkey Laboratories, Inc., Eden Prairie, MN (US)

(21) Appl. No.: 14/267,603

(22) Filed: May 1, 2014

Related U.S. Application Data
(60) Provisional application No. 61/818,365, filed on May 1, 2013.

(51) Int. Cl. H04R 25/00

(52) U.S. Cl. CPC H04R 25/554; H04R 2225/51
USPC 381/315

(57) ABSTRACT

A hearing assistance device, such as a hearing aid, includes an antenna for wireless communication. The antenna has one or more conductor dimensions that are approximately optimized for minimizing effects of head loading, which vary among users. In one embodiment, a conductor dimension of the antenna is identified for substantially affecting an effect of head loading on the antenna when the hearing assistance device is worn by a user. Performance of the wireless communication using the antenna is evaluated based on one or more performance criteria. The conductor dimension is approximately minimized while the performance of the wireless communication satisfies the one or more performance criteria.

### CLAIM OF PRIORITY

The present application claims the benefit of priority under 35 U.S.C. §119(e) of U.S. Provisional Patent Application Ser. No. 61/818,365, filed on May 1, 2013, which application is incorporated herein by reference in its entirety.

### TECHNICAL FIELD

This document relates generally to hearing assistance systems and more particularly to a hearing assistance device that includes an antenna for wireless communication with one or more conductor dimensions optimized to reduce head loading.

### BACKGROUND

Hearing aids are used to assist patients suffering hearing loss by transmitting amplified sounds to ear canals. The sounds may be detected from a patient's environment using the microphone in a hearing aid and/or received from a streaming device via a wireless link. Wireless communication may also be performed for programming the hearing aid and receiving information from the hearing aid. In one example, a hearing aid is worn in and/or around a patient's ear. Patients generally prefer that their hearing aids are minimally visible or invisible, do not interfere with their daily activities, and easy to maintain. The hearing aids may each include an antenna for the wireless communication. Due to the loading effect of the patient's body on the antenna, there is a need for optimizing performance of the wireless communication without increasing size of a hearing aid.

### SUMMARY

A hearing assistance device, such as a hearing aid, includes an antenna for wireless communication. The antenna has one or more conductor dimensions that are approximately optimized for minimizing effects of head loading, which vary among users. In one embodiment, a conductor dimension of the antenna is identified for substantially affecting an effect of head loading on the antenna when the hearing assistance device is worn by a user. Performance of the wireless communication using the antenna is evaluated based on one or more performance criteria. The conductor dimension is approximately minimized while the performance of the wireless communication satisfies the one or more performance criteria.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is an illustration of an embodiment of a hearing aid including an antenna.

FIG. 2 is an illustration of an embodiment of the antenna showing its position relative to the head of a hearing aid wearer.

FIG. 3 is an illustration of an embodiment of the antenna.

FIG. 4 is an illustration of another embodiment of the antenna.

FIG. 5 is a flow chart illustrating an embodiment of a method for optimizing the antenna for wireless communication.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

This document discusses a hearing assistance device with an antenna that is configured to provide stable performance of wireless communication for different wearers and/or different environments. An antenna when placed next to the wearer's head (or any other dielectric object) will experience a shift in impedance. If this shift in impedance is too large for the antenna matching network of the hearing assistance device to account for at a certain frequency, the wireless communication at that frequency will either operate with degraded performance or become inoperable. Examples of solutions to this problem include adding more capacitor banks to make the matching network tunable and increasing spacing between the antenna and the wearer. However, such solutions increase the complexity, power consumption, size, and/or visibility of the hearing assistance device, none of which is desirable, especially when the hearing assistance device is a hearing aid.

The present subject matter provides an antenna with one or more conductor dimensions approximately optimized for use in a hearing assistance device such as a hearing aid. The antenna is approximately optimized for minimal shift in impedance when the hearing aid is placed on the wearer's head (e.g., in and/or around an ear) while still being able to tune with one external discrete component (i.e., without using a tunable matching network). This provides for a performance of a wireless communication system for hearing aids that is substantially stable and predictable for different wearers by reducing variation in head loading effects across these wearers, while reducing the size of the hearing aids by eliminating the need for individualized and/or dynamic control of the matching network associated with the antenna.

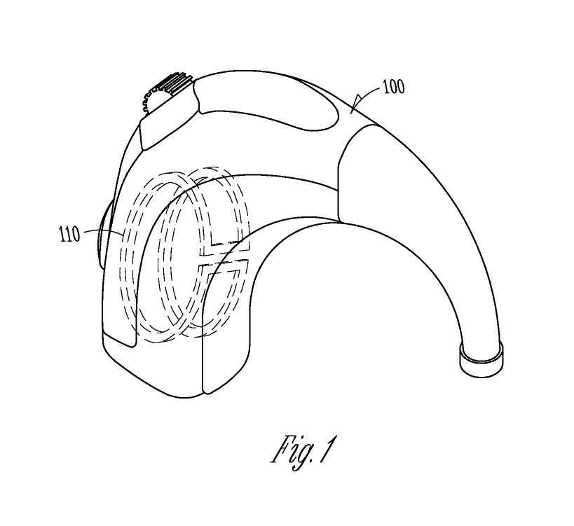

FIG. 1 is an illustration of an embodiment of a hearing aid 100 including an antenna 110 for wireless communication with another device. In the illustrated example, hearing aid 100 is a behind-the-ear (BTE) type hearing aid, and antenna 110 is a parallel-loop type antenna housed in the case of hearing aid 100. While the BTE type hearing aid and the parallel-loop type antenna are illustrated as an example, the present subject matter is applicable to any type hearing aid or other hearing assistance device with an antenna of any type that may be affected by head loading when being worn by a person. Examples of antenna 110 include those discussed in U.S. patent application Ser. No. 12/638,720, entitled “PARALLEL ANTENNAS FOR STANDARD FIT HEARING ASSISTANCE DEVICES”, filed on Dec. 15, 2009, published as US 2010/0158293, U.S. patent application Ser. No. 12/340,604, entitled “ANTENNAS FOR STANDARD FIT HEARING ASSISTANCE DEVICES”, filed on Dec. 15, 2008, published as US 2010/0158291, U.S. patent application Ser. No. 12/340,600, entitled “ANTENNAS FOR CUSTOM FIT HEARING ASSISTANCE DEVICES”, filed on Dec. 19, 2008, published as US 2010/0158295, and U.S. Pat. No. 7,593,538, entitled “ANTENNAS FOR HEARING AIDS”, all assigned to Starkey Laboratories, Inc., which are incorporated herein by reference in their entirety. In various embodiments, antenna 110 includes one or more conductor dimensions that are determined based on considerations of effects of head loading. In various embodiments, the one or more dimensions are approximately optimized for minimizing the effects of head loading. When being approximately optimized, the variation in impedance of antenna 110 with changes in the head loading is approximately minimized for the frequency range of the wireless communication. Consequently, the antenna does not need to be individually tuned for each wearer.

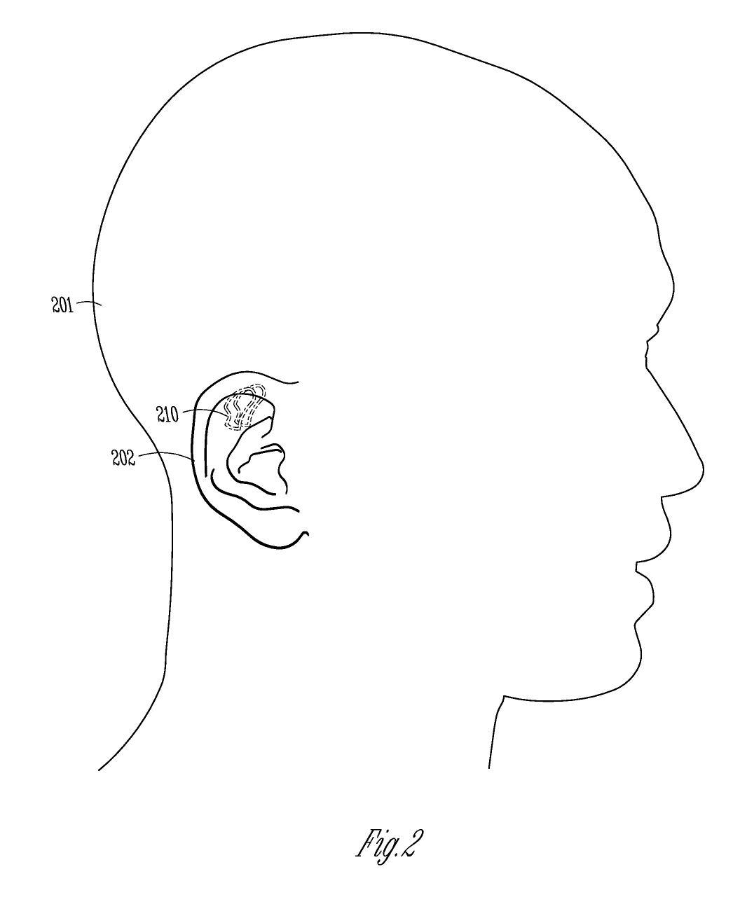

FIG. 2 is an illustration of an embodiment of an antenna 210 showing its position relative to a head 201 and an ear 202 of a hearing aid wearer. Antenna 210 represents an embodiment of antenna 110 and has a configuration of a “butterfly antenna” as a specific example. FIG. 2 illustrates, as a specific example, the position of antenna 210 as a parallel-loop type antenna of a BTE type hearing aid when the hearing aid is worn by the hearing aid wearer. In various embodiments, one or more conductor dimensions of antenna 210 that interfere with head 201 to a degree that results in substantial effective permittivity changes between different wearers and/or environments are approximately minimized while maintaining the function of antenna 210 required for the wireless communication. The minimization of the one or more conductor dimensions minimizes capacitance variation in antenna 210 between the different wearers and/or environments. In various embodiments, the one or more conductor dimensions are each a dimension of a conductive portion of antenna 210. The one or more conductors may include any conductive material suitable for the required functionality of antenna 210. An example of the one or more conductors includes copper. Examples of the one or more conductor dimensions include dimensions of conductive portions of antenna 210 that are measured along directions approximately parallel to the hearing aid wearer's sagittal plane. Such directions are also approximately parallel to a portion of the surface of head 201 that is adjacent to antenna 210 when the hearing aid is worn by the hearing aid wearer.

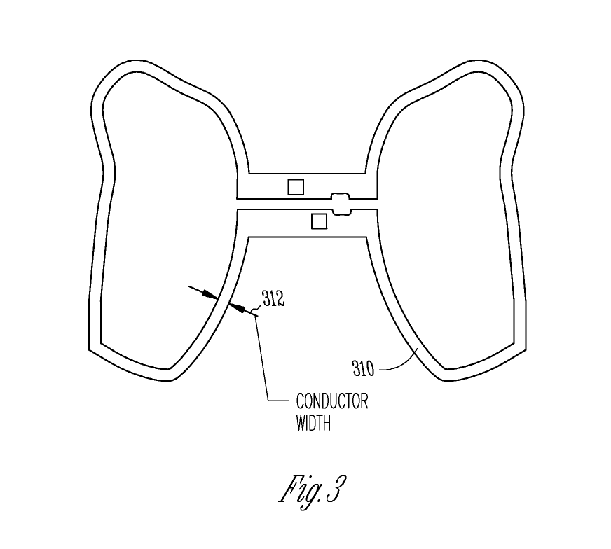

FIG. 3 is an illustration of an embodiment of an antenna 310. Antenna 310 represents an embodiment of antenna 110 and has a configuration of the “butterfly antenna” (of the parallel-loop type) as a specific example. Antenna 310 as illustrated in FIG. 3 includes a conductor trace (such as copper trace) shown in an unfolded (flattened) state. In one embodiment, antenna 310 is a flex circuit antenna including the conductor trace on a flex circuit substrate. An example of such a flex circuit antenna is discussed in U.S. patent application Ser. No. 12/638,720, entitled “PARALLEL ANTENNAS FOR STANDARD FIT HEARING ASSISTANCE DEVICES”, filed on Dec. 15, 2009, published as US 2010/0158293, assigned to Starkey Laboratories, Inc., which is incorporated herein by reference in its entirety. The conductor trace has a conductor width 312 being an example of the one or more conductor dimensions to be approximately optimized. In one embodiment, conductor width 312 is approximately optimized by being minimized to the extent that antenna 310 can still be tuned for the wireless communication with a radio device with performance meeting one or more specified criteria. In one example, when antenna 310 is housed in the case of a BTE type hearing aid worn around the wearer's ear, conductor width 312 is measured along a direction that is approximately parallel to the wearer's sagittal plane.

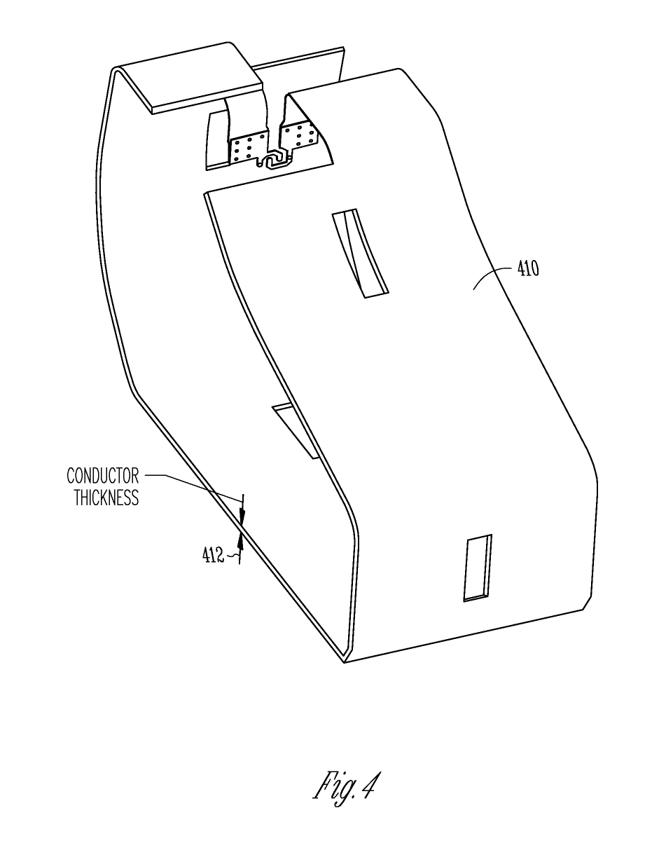

FIG. 4 is an illustration of an embodiment of an antenna 410. Antenna 410 represents another embodiment of antenna 110 and has a configuration of the “band antenna” as a specific example. Antenna 410 as illustrated in FIG. 3 is also for use in a BTE type hearing aid as a specific example, and is made of a conductive material such as copper. Antenna 410 has a conductor thickness 412 being an example of the one or more conductor dimensions to be approximately optimized. In one example, when antenna 410 is housed in the case of a BTE type hearing aid worn around the wearer's ear, conductor thickness 412 is measured along a direction that is approximately parallel to the wearer's sagittal plane. In one embodiment, conductor thickness 412 is approximately optimized by being minimized to the extent that antenna 410 can still be tuned for the wireless communication with a radio device with performance meeting one or more specified criteria. In various embodiments, use of the band antenna configuration also reduces current proximity to tissue by allowing axial current distribution.

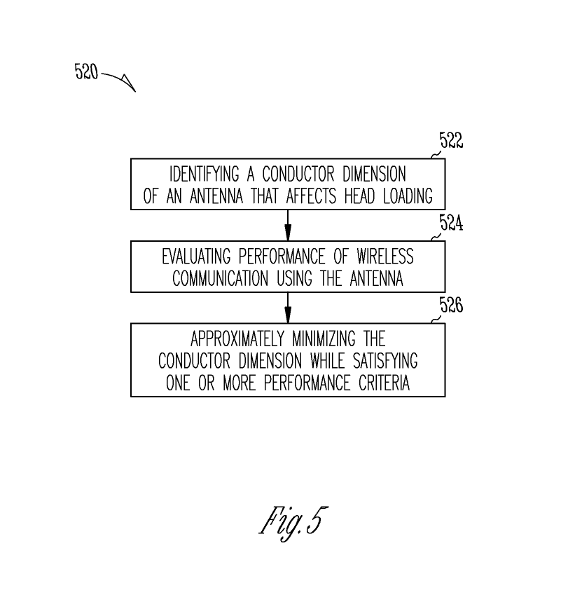

FIG. 5 is a flow chart illustrating an embodiment of a method 520 for optimizing an antenna of a hearing assistance device such as a hearing aid for wireless communication. Examples of the antenna include all the antennas discussed in this document. In one embodiment, method 520 is performed to optimize antenna 110, including its various embodiments discussed in this document, for the wireless communication to and from hearing aid 100 as discussed in this document.

At 522, a conductor dimension of the antenna that affects an effect of head loading on the antenna is identified. The effect of head loading includes changes in the impedance of the antenna when the hearing assistance is worn by the wearer and the antenna interferes with the head of the wearer. The conductor dimension is a measure of size of a conductive portion of the antenna that substantially affects the loading effect. In one example, the dimension is considered to substantially affect the loading effect when changing of the dimension may produce a measurable change in performance of the wireless communication.

At 524, performance of the wireless communication is evaluated using the antenna based on one or more performance criteria. For example, one or more parameters representative of the performance of the wireless communication are measured and compared to one or more corresponding thresholds specified in the one or more performance criteria. Examples of such one or more parameters include various received signal strength indicators and various data transmission error rates associated with the wireless communication.

At 526, the conductor dimension is approximately minimized while the performance satisfies the one or more performance criteria. The performance satisfies the one or more performance criteria when, for example, each of the one or more parameters representative of the performance of the wireless communication reaches or exceeds its corresponding specified threshold.

In various embodiments, method 520 is performed for any one or more conductor dimensions of the antenna. For example, when the antenna includes a conductor having different dimensions at different segments, each of the different dimensions may be identified at 522 if that dimension substantially affects the head loading. In various embodiments, the performance of the wireless communication may be evaluated for different frequencies at which the wireless communication may operate. The performance satisfies the one or more performance criteria for all these different frequencies.

While illustrated in FIGS. 1-4 with an antenna in a BTE type hearing aid as a specific example, the present subject matter is applicable for any antennas that may interfere with human body or other object in their use and are therefore subject to various loading effects. The present subject matter is also applicable for any antenna types including, but not limited to dipoles, monopoles, patches, and combinations of such types. The application of the present subject matter eliminates the use of certain hearing aid circuit components such as a tuning circuit that can be adjusted for individual wearers and/or environments, and prevents the hearing aid from failing to be tuned for one or more necessary operating frequencies for its wireless communication. In various embodiments, the present subject matter facilitates miniaturization of wireless hearing aids and improves antenna performance by reducing deteriorating effects of human body loading.

The present subject matter is demonstrated for hearing assistance devices, including hearing aids, including but not limited to, invisibly-in-canal (IIC), completely-in-canal (CIC), in-the-canal (ITC), in-the-ear (ITE), BTE, or receiver-in-canal (RIC) type hearing aids. It is understood that BTE type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices, wireless earphones, and wireless ear buds. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for optimizing an antenna of a hearing assistance device for wireless communication, the method comprising:
identifying at least one conductor dimension of the antenna that affects head loading on the antenna when the hearing assistance device is worn by a wearer;
evaluating performance of the wireless communication using the antenna based on one or more performance criteria; and
reducing variation in the head loading across different wearers by approximately minimizing the at least one conductor dimension while the performance of the wireless communication satisfies the one or more performance criteria.

2. The method of claim 1, wherein identifying the at least one conductor dimension comprises identifying a dimension of a conductive portion of the antenna measured along a direction approximately parallel to the wearer's sagittal plane when the hearing assistance device is worn by the wearer.

3. The method of claim 2, wherein evaluating the performance of the wireless communication comprises:
measuring one or more parameters representative of the performance of the wireless communication; and
comparing the one or more parameters to one or more corresponding thresholds specified in the one or more performance criteria.

4. The method of claim 3, wherein the one or more parameters comprise a received signal strength indicator.

5. The method of claim 3, wherein the one or more parameters comprise a data transmission error rate.

6. The method of claim 3, wherein evaluating the performance of the wireless communication comprises evaluating the performance of the wireless communication for a plurality of frequencies at which the wireless communication operates.

7. The method of claim 6, wherein identifying the at least one conductor dimension comprises identifying a dimension in each segment of segments of the antenna, the segments having different dimensions.

8. A method for providing a hearing assistance device with capability of performing wireless communication, the method comprising:
providing a hearing aid with an antenna for the wireless communication;
identifying at least one conductor dimension of the antenna that contributes to variation in head loading on the antenna among different wearers of the hearing aid;
evaluating performance of the wireless communication using the antenna based on one or more performance criteria; and
approximately minimizing the at least one conductor dimension to reduce the variation in head loading on the antenna while the performance of the wireless communication satisfies the one or more performance criteria.

9. The method of claim 8, wherein providing the hearing aid with the antenna comprises providing a behind-the-ear (BTE) type hearing aid with the antenna.

10. The method of claim 9, where providing the BTE type hearing aid with the antenna comprises providing the BTE type hearing aid with a parallel-loop antenna.

11. The method of claim 9, where providing the BTE type hearing aid with the antenna comprises providing the BTE type hearing aid with a band antenna.

12. The method of claim 8, wherein identifying the at least one conductor dimension comprises identifying a dimension of a conductive portion of the antenna measured along a direction approximately parallel to the wearer's sagittal plane when the hearing aid is worn by the wearer.

13. The method of claim 12, wherein evaluating the performance of the wireless communication comprises:
measuring one or more parameters representative of the performance of the wireless communication; and
comparing the one or more parameters to one or more corresponding thresholds specified in the one or more performance criteria.

14. The method of claim 13, wherein the one or more parameters comprise at least one of a received signal strength indicator and a data transmission error rate.

15. The method of claim 13, wherein evaluating the performance of the wireless communication comprises evaluating the performance of the wireless communication for a plurality of frequencies at which the wireless communication operates.

16. The method of claim 15, wherein identifying the conductor dimension comprises identifying a dimension in each segment of segments of the antenna, the segments having different dimensions.

17. A hearing assistance device, comprising:
a housing for the hearing assistance device configured to be worn by a wearer; and
antenna means disposed in the housing for performing wireless communication, the antenna means configured for reducing variation in head loading on the antenna means across different wearers of the hearing assistance device while satisfying one or more performance criteria of the wireless communication.

18. The hearing assistance device of claim 17, wherein the housing for the hearing assistance device comprises a housing of a behind-the-ear (BTE) type hearing aid.

19. The hearing assistance device of claim 17, wherein the antenna means comprises a flex circuit antenna including a flex circuit substrate and a conductive trace on the flex circuit substrate.

20. The hearing assistance device of claim 19, wherein the conductive dimension is a width of the conductive trace.
